(19) United States
(12) Patent Application Publication
(10) Pub. No.: US 2025/0102741 A1
(43) Pub. Date: Mar. 27, 2025

(54) COUPLER STRUCTURALLY CONFIGURED TO MECHANICALLY COUPLE A FIBER CABLE JACKET WITH A MECHANICAL FIBER CONNECTOR TO ENHANCE CONNECTION OF AN OPTICAL FIBER TO THE FIBER CONNECTOR

(71) Applicant: PPC BROADBAND, INC., East Syracuse, NY (US)

(72) Inventors: Raymond PALINKAS, Canastota, NY (US); Henry SAUVAIN, Syracuse, NY (US); Peter CARAPELLA, Fayetteville, NY (US); Noah MONTENA, Syracuse, NY (US); Nicholas CLAVER, Camillus, NY (US); William CRAWFORD, Syracuse, NY (US)

(73) Assignee: PPC BROADBAND, INC., East Syracuse, NY (US)

(21) Appl. No.: 18/899,025

(22) Filed: Sep. 27, 2024

Related U.S. Application Data
(60) Provisional application No. 63/540,701, filed on Sep. 27, 2023.

(51) Int. Cl. G02B 6/38

(52) U.S. Cl. CPC G02B 6/3889

(57) ABSTRACT

A coupler configured to cover an exposed portion of an optical fiber in a jacketless portion of a fiber optic cable and mechanically couple the fiber optic cable with a fiber optic connector includes a cover portion that may be configured to be disposed around a fiber optic cable. A jacketless portion of the cable may extend along a length of the cable between a jacketed portion of the cable and a fiber optic connector; the cover portion may be configured to provide a mechanical connection between the cable and the fiber optic connector so as to enhance a connection of the fiber optic connector to the cable; and the cover portion may be configured to protect an exposed portion of an optical fiber that extends through the jacketless portion of the cable so as to so as to enhance a connection of the fiber optic connector to the cable.

### CROSS-REFERENCE TO RELATED APPLICATIONS

This application claims the benefit of U.S. Provisional Application No. 63/540,701 filed Sep. 27, 2023, the disclosure of which is hereby incorporated by reference herein in its entirety.

### BACKGROUND

The present disclosure relates generally to cable connection and, in particular, to optical fiber cable connection with an optical fiber connector.

Telecommunications and other systems include wire, optical fiber, and/or other signal and/or power transmission lines that are routed through a conduit or other protective structure. The conduit, for example, can be flexible while also providing structural protection for a wire or fiber inside the cable. In some applications, it is desirable to mechanically connect an outer sheath of the cable to connectors at both ends of the cable. Due to the nature of making optical fiber connections, for example, it can be difficult to mechanically or structurally connect the outer sheath of the cable to connectors at both ends.

### SUMMARY

The present disclosure provides a much-needed device for mechanically or structurally attaching a sheath of a cable, for example, an optical fiber cable, to a connector, for example, an optical fiber connector, while also facilitating connection of, for example, the optical fiber to, for example, the optical fiber connector.

Embodiments provide an elongated “strain relief” boot that initially slides freely over the cable sheath or jacket. With the boot pushed back on the cable, standard termination is achieved with, for example, 900 or 250 micron fiber to the connector. In embodiments, the elongated boot has a “c” clip feature at both sides that are initially in the open or not engaged position. Once termination is completed to the fiber, the boot is pushed up onto the connector where the c clip is snapped into a recess feature at the end of the connector. At the opposite end or cable side of the boot, the c clip feature is then pressed into one or more grooves or ribs in the cable sheath or jacket. This provides a highly secure mechanical connection to both the connector and cable.

Embodiments include a first coupler portion, a cover portion, and a second coupler portion that may be structurally configured to provide a mechanical connection between the fiber optic cable and the fiber optic connector so as to enhance a connection of the connector portion to the fiber optic cable; and the first coupler portion, the cover portion, and the second coupler portion may be structurally configured to protect an exposed portion of an optical fiber that extends through a jacketless portion of the fiber optic cable so as to so as to enhance a connection of the fiber optic connector to the fiber optic cable.

Embodiments provide a coupler configured to cover an exposed portion of an optical fiber in a jacketless portion of a fiber optic cable and mechanically couple the fiber optic cable with a fiber optic connector including: a cover portion that may be structurally configured to be disposed around a fiber optic cable; a first coupler portion that may be structurally configured to couple the cover portion with the fiber optic cable; and a second coupler portion that may be structurally configured to couple the cover portion with a connector portion. The connector portion may include a fiber optic connector; the cover portion may be structurally configured to cover a jacketless portion of the fiber optic cable that extends along a length portion of the fiber optic cable between a jacketed portion of the fiber optic cable and the connector portion; the first coupler portion may be configured to overlap a portion of the jacketed portion of the fiber optic cable in a length direction of the fiber optic cable; the second coupler portion may be configured to overlap a portion of the connector portion; the first coupler portion, the cover portion, and the second coupler portion may be structurally configured to provide a mechanical connection between the fiber optic cable and the fiber optic connector so as to enhance a connection of the connector portion to the fiber optic cable; and the first coupler portion, the cover portion, and the second coupler portion may be structurally configured to protect an exposed portion of an optical fiber that extends through the jacketless portion of the fiber optic cable so as to so as to enhance a connection of the fiber optic connector to the fiber optic cable.

In particular embodiments, the first coupler portion, the cover portion, and the second coupler portion may form a clam shell.

In particular embodiments, the claim shell may comprise a first clam shell portion and a second clam shell portion that are connected to each other by a clam shell connector portion.

In particular embodiments, the second coupler portion may comprise a threaded portion that is structurally configured to engage a threaded portion of the fiber optic connector.

In particular embodiments, the second coupler portion may comprise a collet portion that may be structurally configured to secure the threaded portion of the second coupler to the threaded portion of the fiber optic connector.

In particular embodiments, the first coupler portion may comprise a collet portion that may be structurally configured to secure the first coupler portion to the cable jacket.

In particular embodiments, the first coupler portion may comprise an insert that may be separate from the cover portion and may be separate from the first coupler portion, and the insert may be structurally configured to engage the cable jacket.

In particular embodiments, the coupler may further comprise an outer covering that covers the cover portion, at least a portion of the first coupler portion, and at least a portion of the second coupler portion.

In particular embodiments, the outer covering may comprise a heat shrink tube.

Embodiments provide a coupler configured to cover an exposed portion of an optical fiber in a jacketless portion of a fiber optic cable and mechanically couple the fiber optic cable with a fiber optic connector including: a cover portion that may be structurally configured to be disposed around a fiber optic cable; a first coupler portion that may be structurally configured to couple the cover portion with the fiber optic cable; and a second coupler portion that may be structurally configured to couple to the cover portion. The first coupler portion may be configured to overlap a portion of the jacked portion of the fiber optic cable in a length direction of the fiber optic cable; the first coupler portion, the cover portion, and the second coupler portion may be structurally configured to provide a mechanical connection between the fiber optic cable and a fiber optic connector so as to enhance a connection of the fiber optic connector to the fiber optic cable; and the first coupler portion, the cover portion, and the second coupler portion may be structurally configured to protect an exposed portion of an optical fiber that extends through a jacketless portion of the fiber optic cable so as to so as to enhance a connection of the fiber optic connector to the fiber optic cable.

In particular embodiments, the second coupler portion may overlap a portion of the fiber optic connector.

In particular embodiments, the jacketless portion may exist between the cable jacket and the fiber optic connector.

In particular embodiments, the first coupler portion, the cover portion, and the second coupler portion may form a clam shell.

In particular embodiments, the claim shell may comprises a first clam shell portion and a second clam shell portion that are connected to each other by a clam shell connector portion.

In particular embodiments, the first coupler portion may comprise an insert that may be separate from the cover portion and may be separate from the first coupler portion, and the insert may be structurally configured to engage the cable jacket.

In particular embodiments, the coupler may further comprise an outer covering that may cover the cover portion, at least a portion of the first coupler portion, and at least a portion of the second coupler portion.

In particular embodiments, the outer covering may comprise a heat shrink tube.

Embodiments provide a coupler configured to cover an exposed portion of an optical fiber in a jacketless portion of a fiber optic cable and mechanically couple the fiber optic cable with a fiber optic connector including a cover portion that may be structurally configured to be disposed around a fiber optic cable. A jacketless portion of the fiber optic cable may extend along a length portion of the fiber optic cable between a jacketed portion of the fiber optic cable and a fiber optic connector; the cover portion may be structurally configured to provide a mechanical connection between the fiber optic cable and the fiber optic connector so as to enhance a connection of the fiber optic connector to the fiber optic cable; and the cover portion may be structurally configured to protect an exposed portion of an optical fiber that extends through the jacketless portion of the fiber optic cable so as to so as to enhance a connection of the fiber optic connector to the fiber optic cable.

In particular embodiments, the coupler may further comprise a first coupler portion that may be structurally configured to couple the cover portion with the fiber optic cable.

In particular embodiments, the first coupler portion may overlap a portion of a cable jacket of the fiber optic cable.

In particular embodiments, the coupler may further comprise a second coupler portion that may be structurally configured to couple the cover portion with the fiber optic connector.

In particular embodiments, the second coupler portion may overlap a portion of the fiber optic connector.

In particular embodiments, the coupler may further comprise an outer covering that may cover the cover portion, at least a portion of the first coupler portion, and at least a portion of the second coupler portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of an exemplary cable cover in accordance with various aspects of the disclosure attached to a cable.

FIG. 2 is a perspective view of a first embodiment of an exemplary cable cover in accordance with various aspects of the disclosure in a partial assembled state.

FIG. 3 is a perspective view of the embodiment of FIG. 2 in a partially assembled state.

FIG. 4 is a perspective view of the embodiment of FIG. 2 in a partially assembled state.

FIG. 5 is a sectional view of the embodiment of FIG. 2 in a partially assembled state.

FIG. 6 is a side view of the embodiment of FIG. 2 in a partially assembled state.

FIG. 7 is a partial perspective view of the embodiment of FIG. 2 in a partially assembled state.

FIG. 8 is a perspective view of the embodiment of FIG. 2.

FIG. 9 is a perspective view of a second embodiment of an exemplary cable cover in accordance with various aspects of the disclosure in a partial assembled state.

FIG. 10 is a side view of the embodiment of FIG. 9.

FIG. 11 is partial sectional view of the embodiment of FIG. 9.

FIG. 12 is a partial sectional view of a part of the embodiment of FIG. 9.

FIG. 13 is a partial exploded view of the embodiment of FIG. 9.

FIG. 14 is a partial side view of the embodiment of FIG. 9.

FIG. 15 is a sectional view of the embodiment of FIG. 9.

FIG. 16 is a perspective view of a third embodiment of an exemplary cable cover in accordance with various aspects of the disclosure in a partial assembled state.

FIG. 17 is a perspective view of the embodiment of FIG. 16.

FIG. 18 is a sectional view of the embodiment of FIG. 16.

FIG. 19 is a perspective view of the embodiment of FIG. 16.

FIG. 20 is a perspective view of the embodiment of FIG. 16 in a partially assembled state.

FIG. 21 is top view of the embodiment of FIG. 16 in a partially assembled state.

FIG. 22 is a top view of the embodiment of FIG. 16.

FIG. 23 is a side view of the embodiment of FIG. 16 in a partially assembled state.

FIG. 24 is a partial perspective view of the embodiment of FIG. 16 in a partially assembled state.

FIG. 25 is an exploded perspective view of a fourth embodiment of an exemplary cable cover in accordance with various aspects of the disclosure.

FIG. 26 is a sectional view of the embodiment of FIG. 25.

FIG. 27 is a perspective view of the embodiment of FIG. 25.

FIG. 28 is a partial exploded view of the embodiment of FIG. 25.

FIG. 29 is a partial sectional view of the embodiment of FIG. 25.

FIG. 30 is a partial sectional view of the embodiment of FIG. 25.

FIG. 31 is a perspective view of the embodiment of FIG. 25 in a partially assembled state.

FIG. 32 is a side view of the embodiment of FIG. 25.

FIG. 33 is a sectional view of a fifth embodiment of an exemplary cable cover in accordance with various aspects of the disclosure.

FIG. 34 is a perspective view of the embodiment of FIG. 33.

FIG. 35 is a perspective view of the embodiment of FIG. 33 in a partially assembled state.

FIG. 36 is a perspective view of the embodiment of FIG. 33 in a partially assembled state.

FIG. 37 is a side view of the embodiment of FIG. 33 in a partially assembled state.

FIG. 38 is an exploded perspective view of a sixth embodiment of an exemplary cable cover in accordance with various aspects of the disclosure.

FIG. 39 is a sectional view of the embodiment of FIG. 38.

FIG. 40 is a perspective view of the embodiment of FIG. 38.

FIG. 41 is a partial exploded view of the embodiment of FIG. 38.

FIG. 42 is a partial exploded view of the embodiment of FIG. 38.

FIG. 43 is a partial sectional view of the embodiment of FIG. 38.

FIG. 44 is a perspective view of the embodiment of FIG. 38 in a partially assembled state.

FIG. 45 is a top view of the embodiment of FIG. 38.

FIG. 46 is a partial exploded view of the embodiment of FIG. 38.

FIG. 47 is an exploded perspective view of a seventh embodiment of an exemplary cable cover in accordance with various aspects of the disclosure.

FIG. 48 is a sectional view of the embodiment of FIG. 47.

FIG. 49 is a perspective view of the embodiment of FIG. 47.

FIG. 50 is a side view of the embodiment of FIG. 47 in a partially assembled state.

FIG. 51 is a partial sectional view of the embodiment of FIG. 47.

FIG. 52 is a perspective view of the embodiment of FIG. 47 in a partially assembled state.

FIG. 53 is a top view of the embodiment of FIG. 47.

FIG. 54 is an exploded perspective view of an eighth embodiment of an exemplary cable cover in accordance with various aspects of the disclosure.

FIG. 55 is a sectional view of the embodiment of FIG. 54.

FIG. 56 is a perspective view of the embodiment of FIG. 54.

FIG. 57 is a partial exploded view of the embodiment of FIG. 54.

FIG. 58 is a partial sectional view of the embodiment of FIG. 54.

FIG. 59 is a perspective view of the embodiment of FIG. 54 in a partially assembled state.

FIG. 60 is a top view of the embodiment of FIG. 54.

### DETAILED DESCRIPTION OF EMBODIMENTS

Embodiments include a first coupler portion, a cover portion, and a second coupler portion that may be structurally configured to provide a mechanical connection between the fiber optic cable and the fiber optic connector so as to enhance a connection of the connector portion to the fiber optic cable; and the first coupler portion, the cover portion, and the second coupler portion may be structurally configured to protect an exposed portion of an optical fiber that extends through a jacketless portion of the fiber optic cable so as to so as to enhance a connection of the fiber optic connector to the fiber optic cable.

Embodiments of the disclosure provide a coupler that covers an exposed portion of an optical fiber, for example, a jacketless portion of a fiber optic cable, in a cable having a cable jacket. The exposed portion is exposed to facilitate connection of the optical fiber to an optical fiber connector. A cover portion of the coupler is structurally configured to cover the exposed portion after the optical fiber is connected to the optical fiber connector, and to provide rigidity and structural protection around the exposed portion.

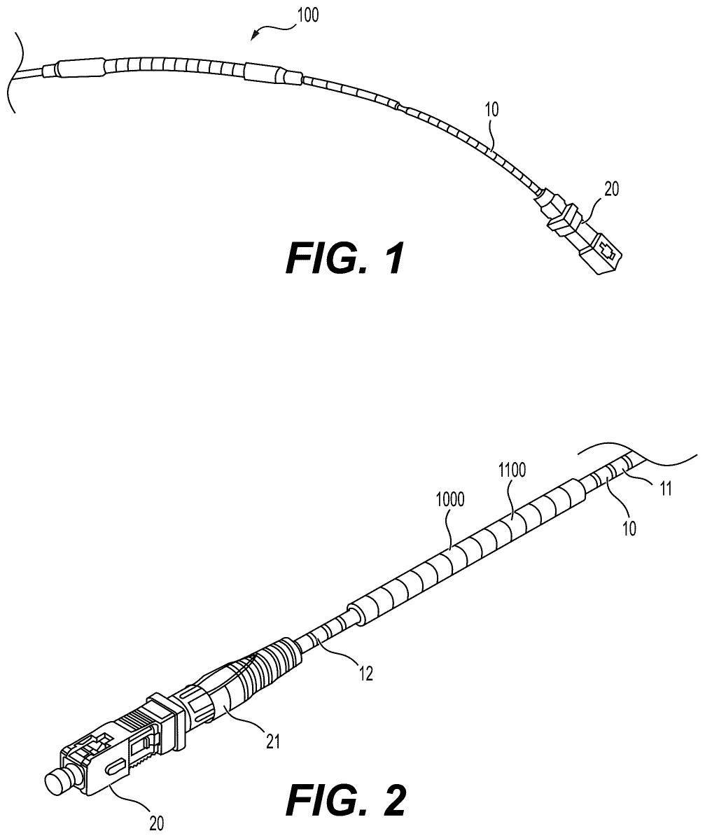

FIG. 1 shows an example of a coupler 100 installed on an optical fiber cable 10 that is connected to an optical fiber connector, for example, a fiber optic connector, 20.

In the various exemplary embodiments shown, a portion of a cable jacket is removed from the optical fiber cable 10 to permit/facilitate connection of an optical fiber inside the optical fiber cable 10 to the optical fiber connector 20.

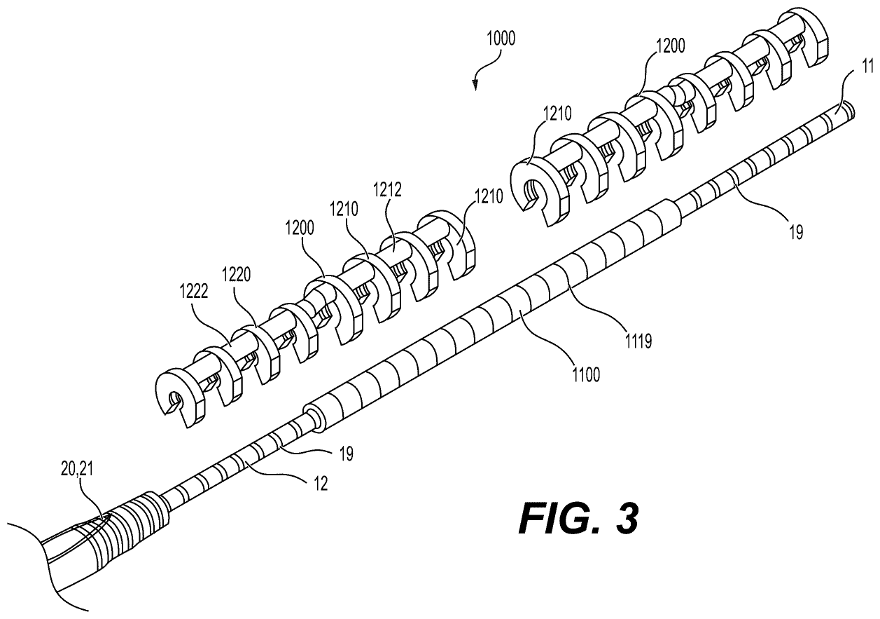

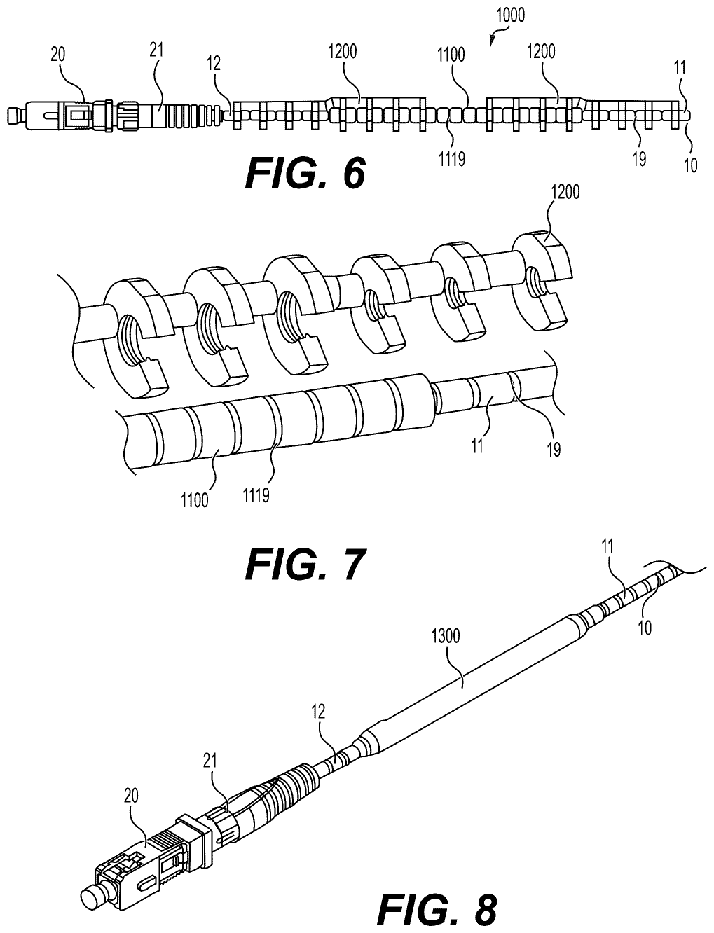

FIGS. 2-8 show an example of a first embodiment of a coupler 1000 in accordance with various aspects of the disclosure. In this example, the coupler 1000 has a cover portion 1100 that covers an exposed portion 18 of an optical fiber 16 inside optical fiber cable 10. Each of two clip portions 1200 (for example, a first coupler portion and a second coupler portion) engages the cover portion 1100 and one of a first portion 11 and a second portion 12 of a cable jacket of the optical fiber cable 10. In this example, the clip portions 1200 are identical and are installed in a mirror arrangement to each other. As shown in the example in FIG. 3, larger clipping portions 1210 are configured to engage the cover portion 1100 and smaller clipping portions 1220 are configured to engage the first portion 11 and the second portion 12 of the cable jacket of the optical fiber cable 10. In this example, the larger clipping portions 1210 are connected by connecting portions 1212, and the smaller clipping portions 1220 are connected by connecting portions 1222. In this example, the cable jacket has a plurality of grooves 19 that, in some examples, provide flexibility to the optical fiber cable 10 while permitting the optical fiber cable 10 to provide structural protection of the optical fiber 16 inside the optical fiber cable 10. The smaller clipping portions 1220 are sized to engage the grooves 19.

In this example, the cover portion 1100 has a plurality of grooves 1119 in its outer surface. In some embodiments, the cover portion 1100 is a piece of cable jacket similar to the cable jacket of the optical fiber cable 10 but having a larger diameter. The larger clipping portions 1210 are sized to engage the grooves 1119.

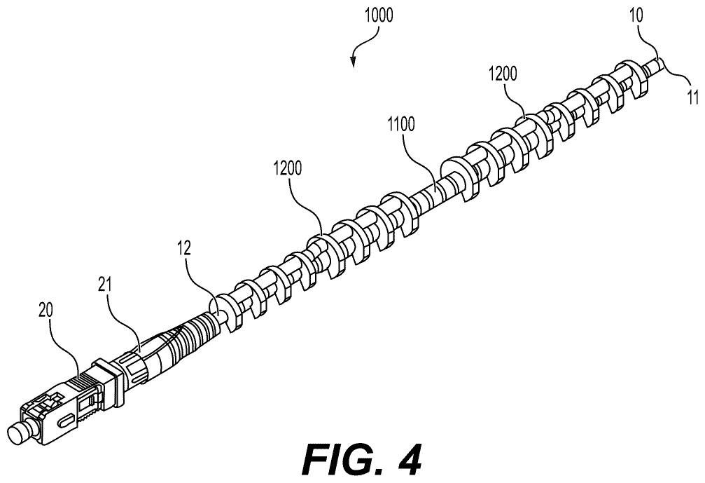

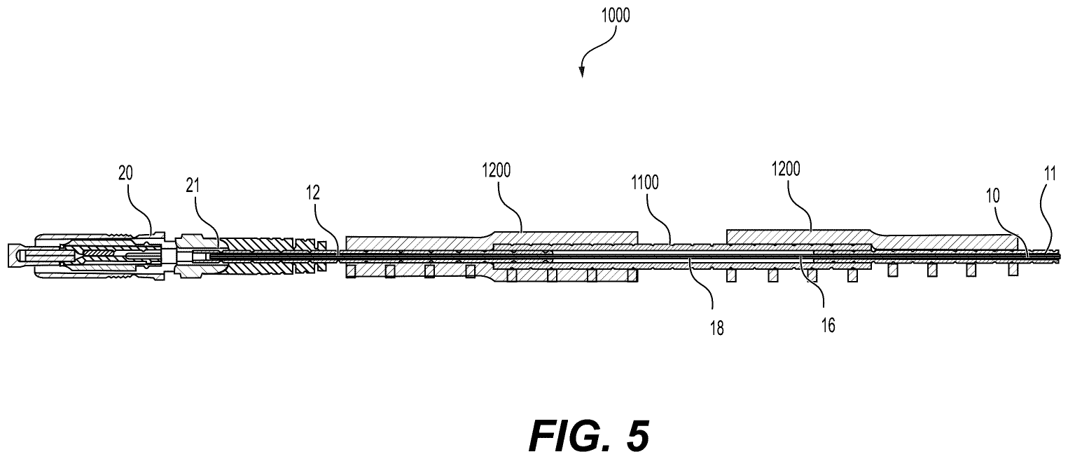

FIGS. 4 and 5 show the coupler 1000 in place after installation. An example of the installation process includes removing a portion of the cable jacket at an end of the optical fiber cable 10, exposing an end portion of the optical fiber 16. The optical fiber 16 is optically and mechanically connected to the optical fiber connector 20. In some examples, optical fiber connector 20 includes a boot 21. A cut is made in the cable jacket of the optical fiber cable 10 to create a free portion (second portion 12) of the cable jacket that is separated from the first portion 11 of the cable jacket. The cut can be made either before or after the optical fiber 16 is connected to the optical fiber connector 20. Before the optical fiber 16 is connected to the optical fiber connector 20, the cover portion 1100 is installed over the first portion 11 of the cable jacket for later deployment over an exposed portion 18 of the optical fiber 16. After the connection of the optical fiber 16 to the optical fiber connector 20 is completed, the second portion 12 of the cable jacket is moved into contact with, and connected to, the optical fiber connector 20. In embodiments, the connection of the second portion 12 to the optical fiber connector 20 is a rigid structural connection.

The movement of the second portion 12 into the position shown in FIG. 5 exposes the exposed portion 18 of the optical fiber 16. As shown in FIG. 5, the cover portion 1100 is moved into position over the exposed portion 18 and held in place by the clip portions 1200. In this manner, the coupler 1000 provides structural protection of the portion (the exposed portion 18) of the optical fiber 16 that would otherwise be vulnerable to potential damage if left exposed, while facilitating connection of the optical fiber 16 to the optical fiber connector 20.

FIG. 8 shows an outer covering 1300 such as, for example, a heat shrink tube, that helps keep the various parts of the coupler 1000 in position and/or creates a waterproof or water-resistant sealing of the coupler 1000 to the optical fiber cable 10. Outer covering 1300 can be used with the other exemplary embodiments shown.

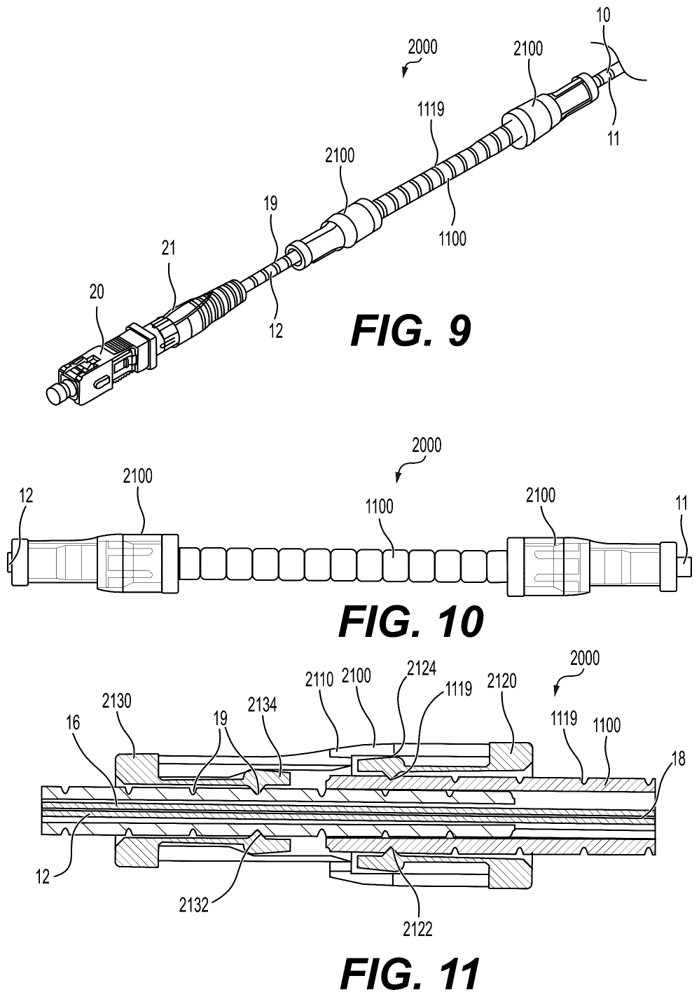

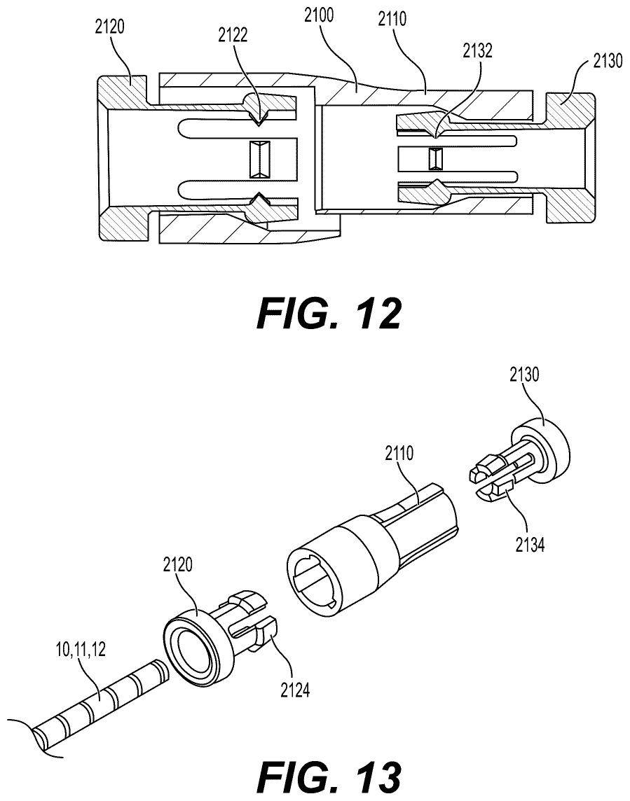

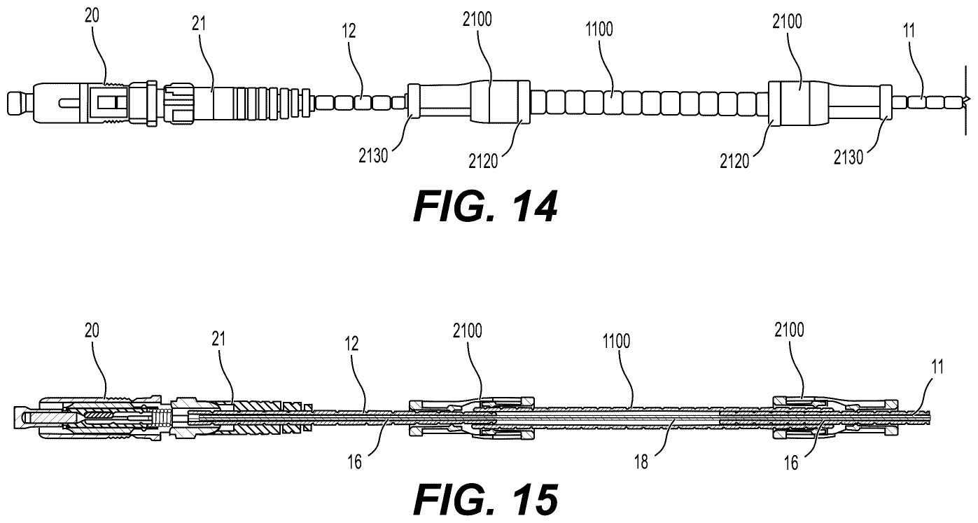

FIGS. 9-15 show an example of a second embodiment of a coupler 2000 in accordance with various aspects of the disclosure. In this example, two couplers 2100, for example, a first coupler portion and a second coupler portion, connect the cover portion 1100 to the first portion 11 and the second portion 12 of the fiber optic cable 10. As shown in FIGS. 11 and 12, the coupler 2100 has a central portion 2110, a larger end portion 2120, and a smaller end portion 2130. The larger end portion 2120 has a plurality of engagement fingers 2124 that engage an internal feature of the central portion 2110 to fix the larger end portion 2120 in the central portion 2110 after the larger end portion 2120 is engaged with the cover portion 1100. Similarly, the smaller end portion 2130 has a plurality of engagement fingers 2134 that engage an internal feature of the central portion 2110 to fix the smaller end portion 2130 in the central portion 2110 after the smaller end portion 2130 is engaged with the respective one of the first portion 11 or the second portion 12 of the fiber optic cable 10. As shown in FIG. 11, the engagement fingers 2134 have protrusions 2132 that engage the grooves 19 in the first and second portions 11, 12 of the optical fiber cable 10. Similarly, the engagement fingers 2124 have protrusions 2122 that engage the grooves 1119 in the cover portion 1100. The above engagements fix the relative positions of the cover portion 1100, the first portion 11, and the second portion 12.

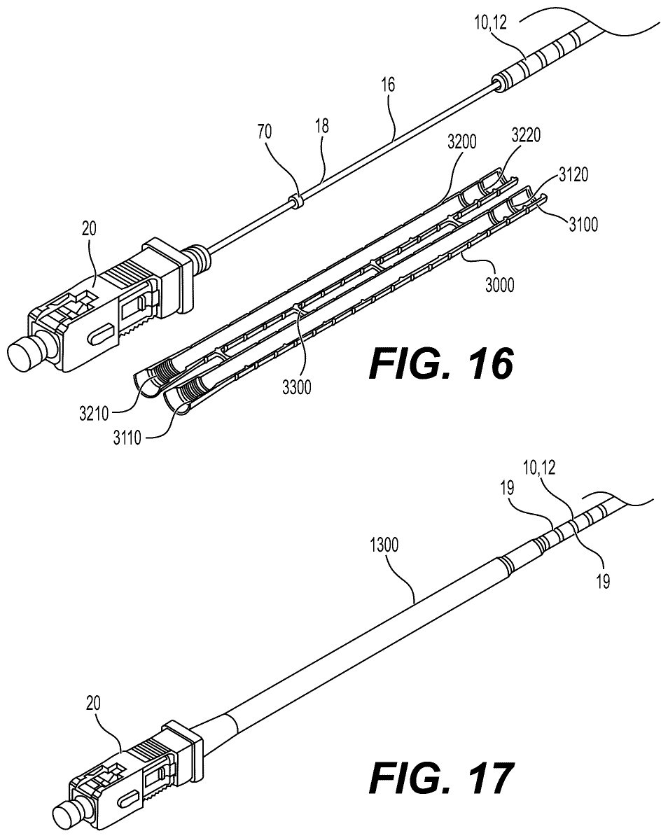

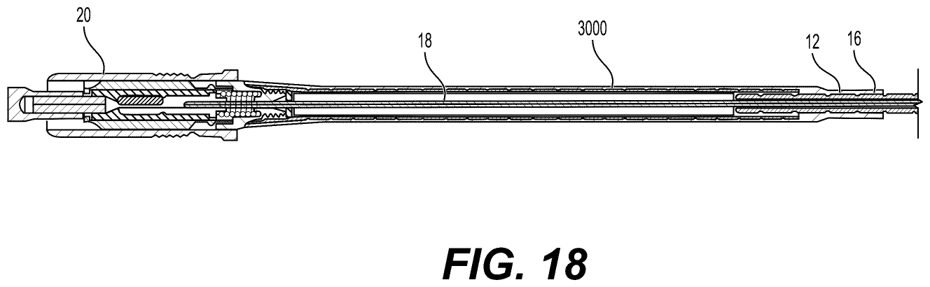

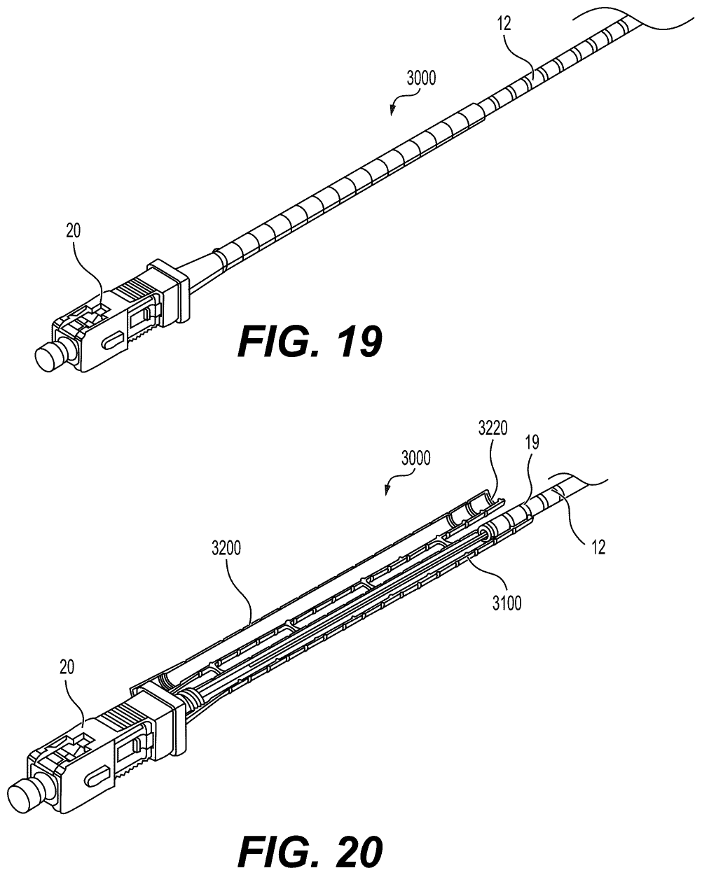

FIGS. 16-24 show an example of a third embodiment of a coupler 3000 in accordance with various aspects of the disclosure. In this example, a clam shell portion 3000 has two halves 3100, 3200. A first half 3100 has at one end a first coupler portion, for example, engagement portion, 3120 that is configured to connect to the second portion 12 of the optical fiber cable 10. The first half 3100 has at the other end a second coupler portion, for example, engagement portion, 3110 that is configured to connect to the optical fiber connector 20. A second half 3200 has at one end a first coupler portion, for example, engagement portion, 3220 that is configured to connect to the second portion 12 of the optical fiber cable 10. The second half 3200 has at the other end a second coupler portion, for example, engagement portion, 3210 that is configured to connect to the optical fiber connector 20. In this example, the first half 3100 and the second half 3200 are attached to each other by connector portions, for example, hinges, 3300.

As shown in FIG. 16, the coupler 3000 is configured to cover the exposed portion 18 of the optical fiber 16 after the optical fiber 16 has been connected to the optical fiber connector 20. FIG. 17 shows the outer covering 1300 installed on the coupler 3000 after installation of the coupler 3000 on the optical fiber cable 10 and the optical fiber connector 20.

This and other embodiments can be used to protect the optical fiber 16 in the case of a fusion or other repair. FIG. 16 shows a fusion repair 70 in the optical fiber 16, 18. Although the fusion repair 70 is shown near the optical fiber connector 20, the fusion (or other) repair can be located at any location along the optical fiber cable 20.

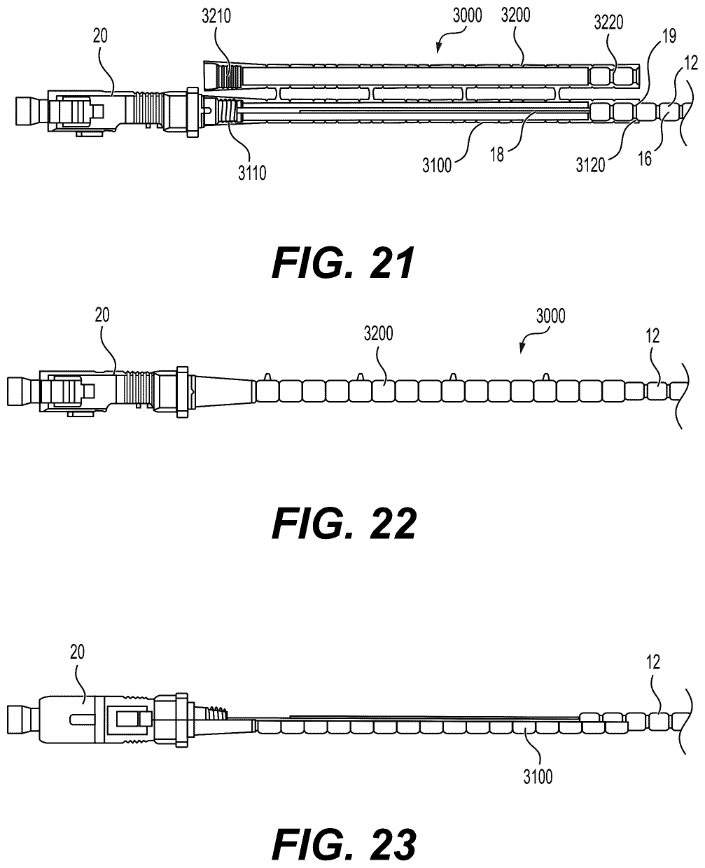

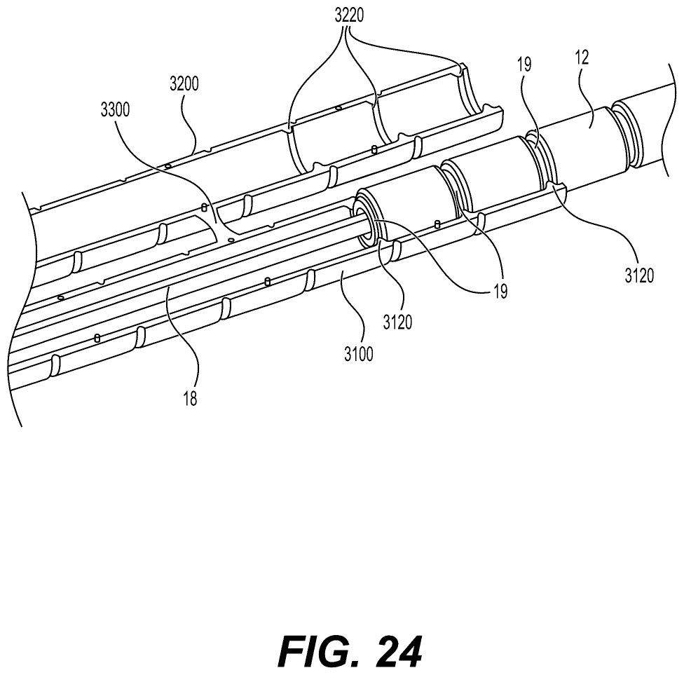

FIG. 21 shows engagement portions 3110 and 3210 engaging threads on the optical fiber connector 20 to secure the coupler 3000 to the optical fiber connector 20. FIG. 24 shows engagement portions 3120 and 3220 engaging the grooves 19 in the second portion 12 of the optical fiber cable 10.

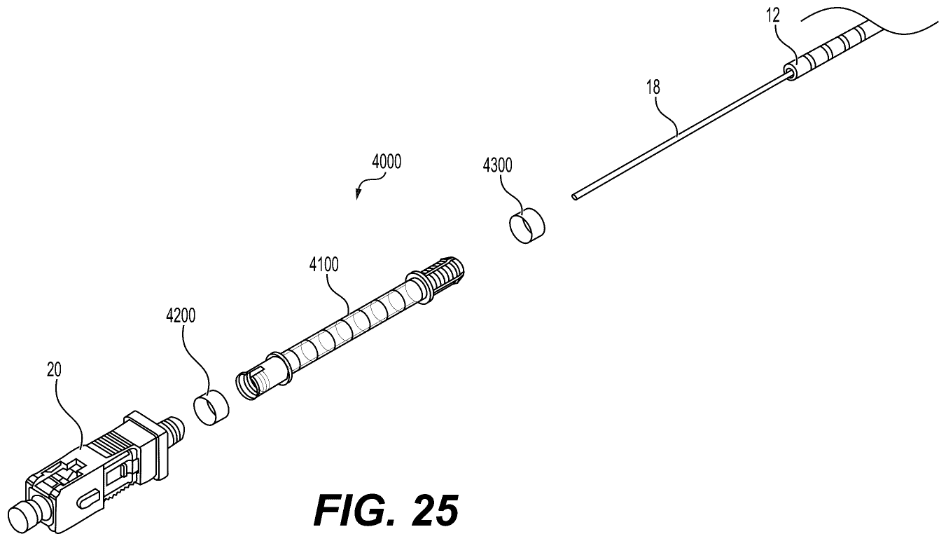

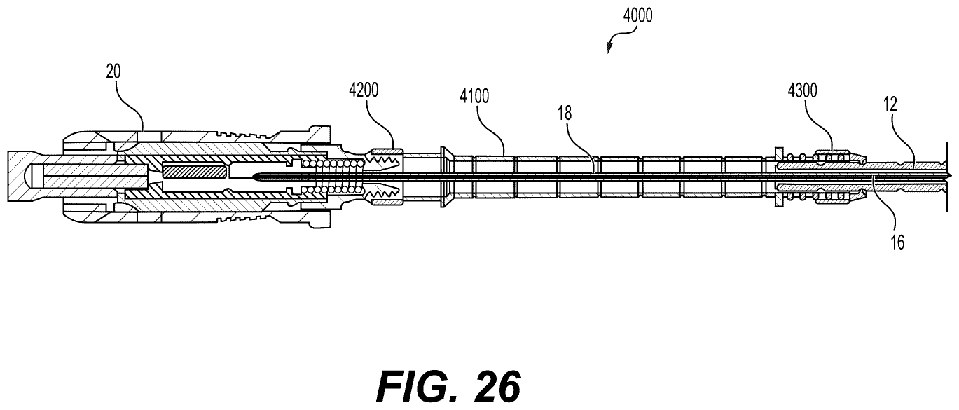

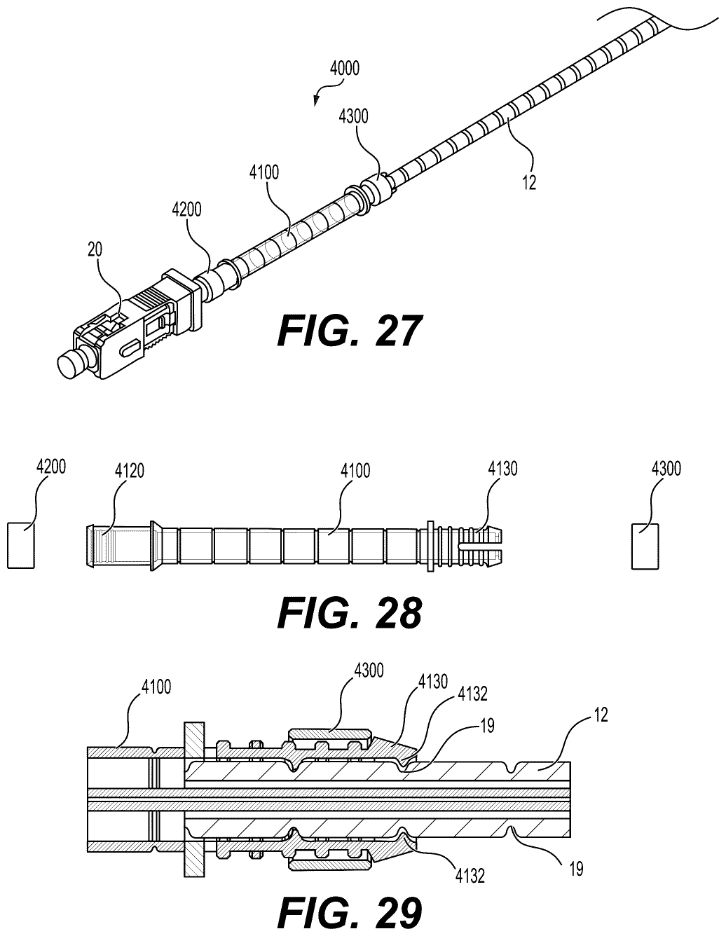

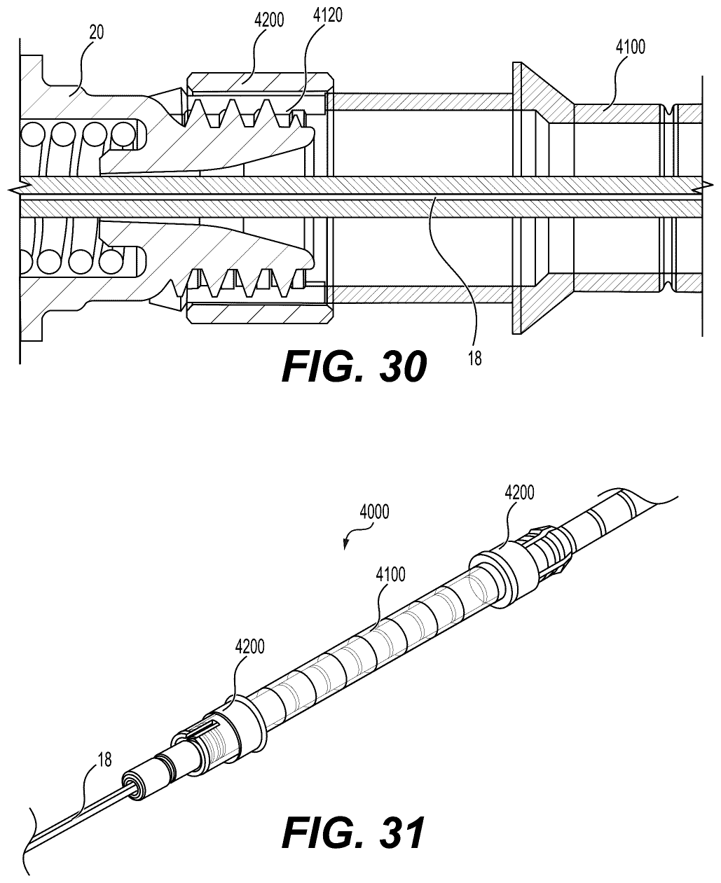

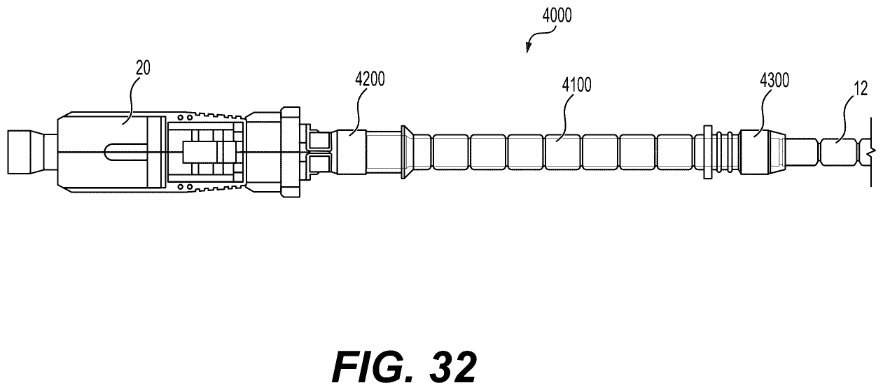

FIGS. 25-32 show an example of a fourth embodiment of a coupler 4000 in accordance with various aspects of the disclosure. In this example, a tubular coupler portion 4100 provides protection for the exposed portion 18 of the optical fiber 16. The tubular coupler portion 4100 is positioned over the second portion 12 of the optical fiber cable 10 prior to the optical fiber 16, 18 being connected to the optical fiber connector 20. After the optical fiber 16, 18 is connected to the optical fiber connector 20, a second coupler portion 4120 of the tubular coupler portion 4100 is moved into contact with, in this example, a threaded portion of the optical fiber connector 20 and a second crimp ring 4200 is crimped around the second coupler portion 4120 to hold it in place (see FIG. 30). A first coupler portion 4130 of the tubular coupler portion 4100 is moved into contact with, in this example, the second portion 12 of the optical fiber cable 10 and a first crimp ring 4300 is crimped around the first coupler portion 4130 to hold it in place (see FIG. 29). FIG. 29 shows protrusions 4132 extending into the grooves 19 of the second portion 12 of the optic fiber cable 10.

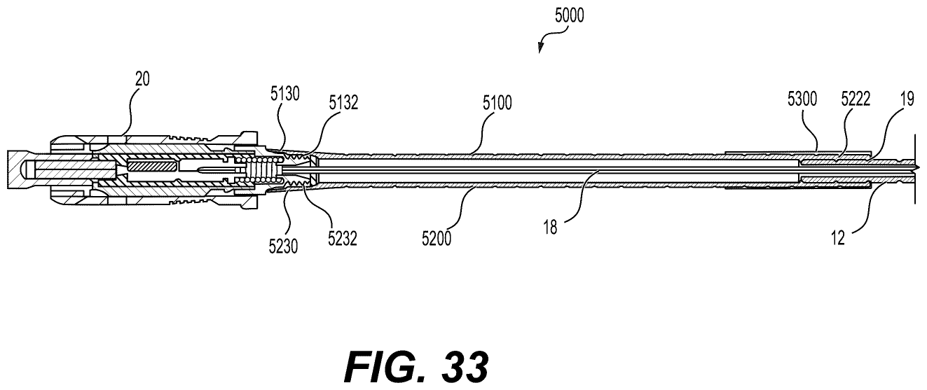

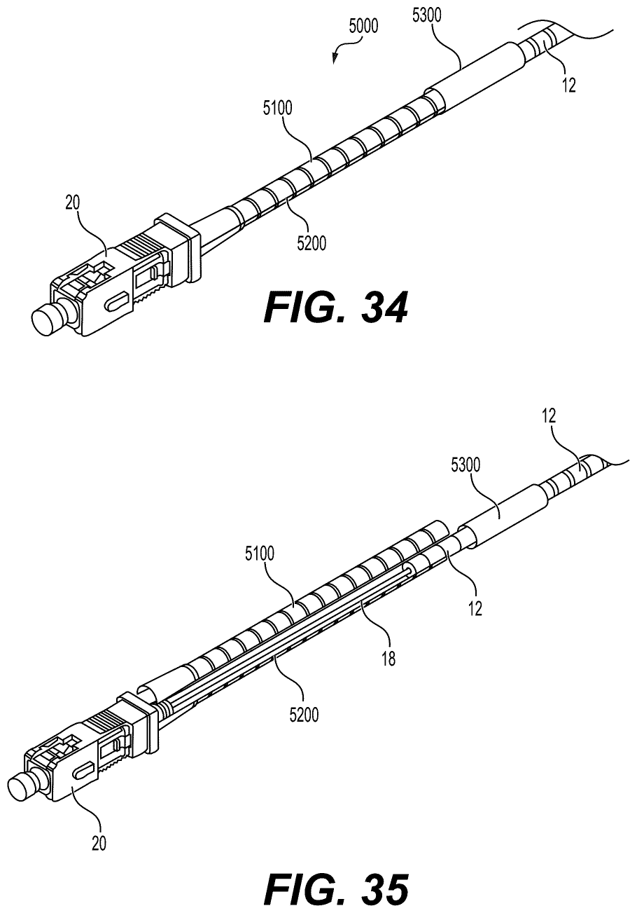

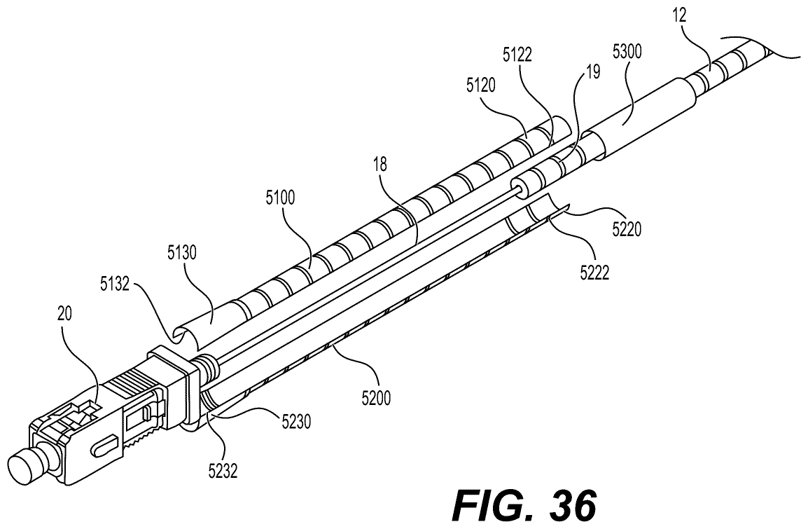

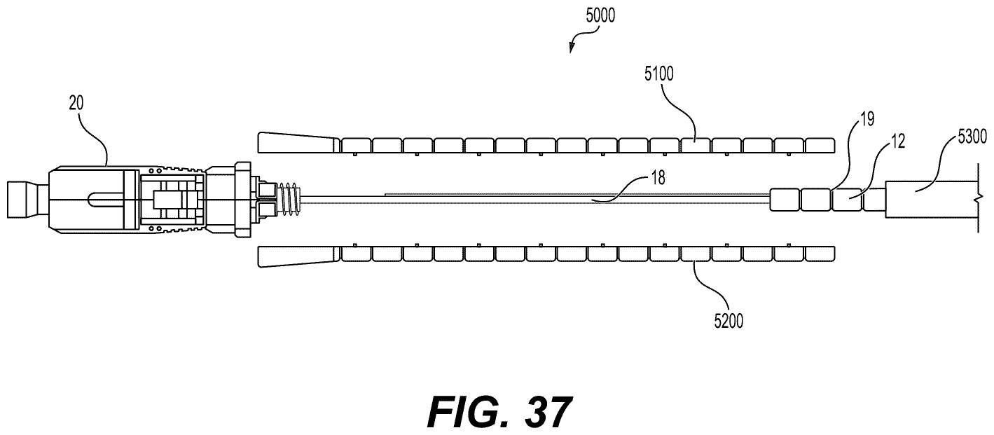

FIGS. 33-37 show an example of a fifth embodiment of a coupler 5000 in accordance with various aspects of the disclosure. In this example, the coupler 5000 has a first clam shell portion 5100 and a second clam shell portion 5200. The first clam shell portion 5100 has at one end a first coupler portion 5120, for example, engagement portions 5122 that are configured to connect to the second portion 12 of the optical fiber cable 10. The first clam shell portion 5100 has at the other end a second coupler portion 5130, for example, engagement portion 5132 that is configured to connect to the optical fiber connector 20. The second clam shell portion 5200 has at one end a first coupler portion 5220, for example, engagement portions 5222 that is configured to connect to the second portion 12 of the optical fiber cable 10. The second clam shell portion 5200 has at the other end a second coupler portion 5230, for example, engagement portion 5232 that is configured to connect to the optical fiber connector 20. In this example, the first clam shell portion 5100 and the second clam shell portion 5200 are not attached to each other until they are installed. In other embodiments, they are attached to each other by connector portions, for example, hinges.

As shown in FIGS. 33-37, the coupler 5000 is configured to cover the exposed portion 18 of the optical fiber 16 after the optical fiber 16 has been connected to the optical fiber connector 20. FIG. 35 shows engagement portions 5132 and 5232 engaging threads on the optical fiber connector 20 to secure the coupler 5000 to the optical fiber connector 20. FIG. 35 shows engagement portions 5122 and 5222 engaging the grooves 19 in the second portion 12 of the optical fiber cable 10. FIG. 33 shows a crimp sleeve 5300 in place to hold the first clam shell portion 5100 and the second clam shell portion 5200 in place on the optical fiber cable 10.

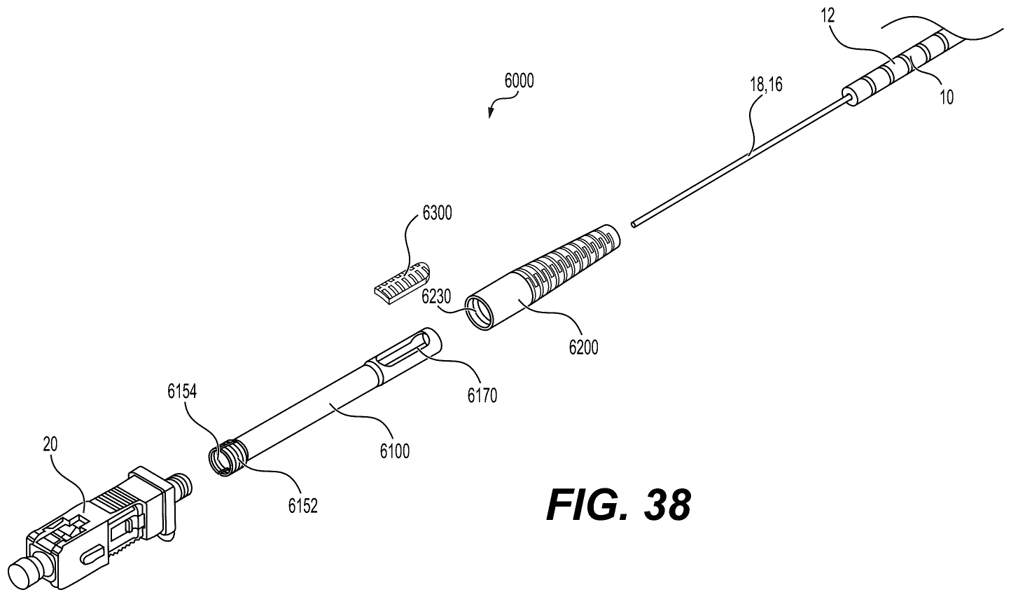

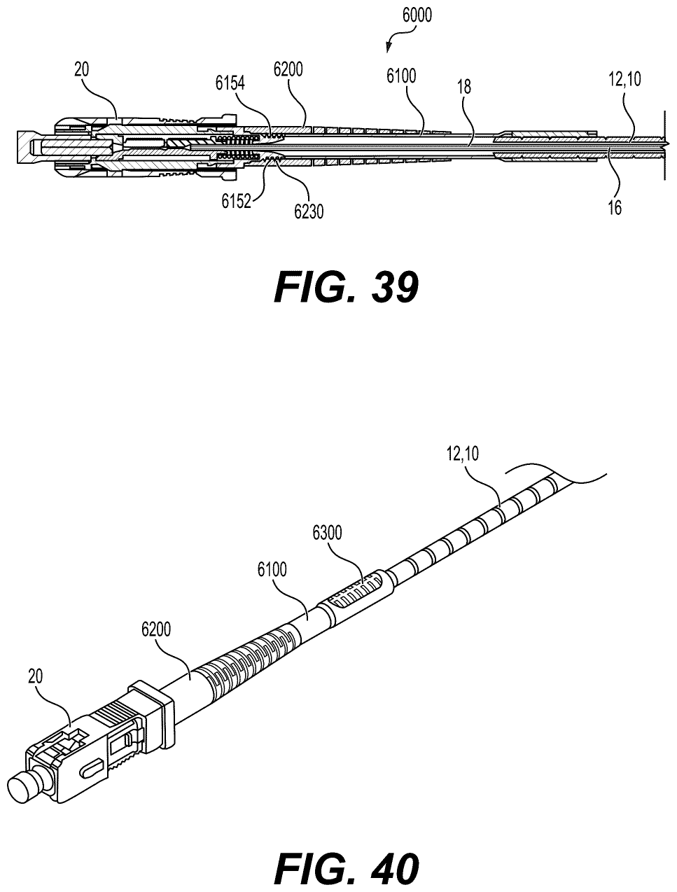

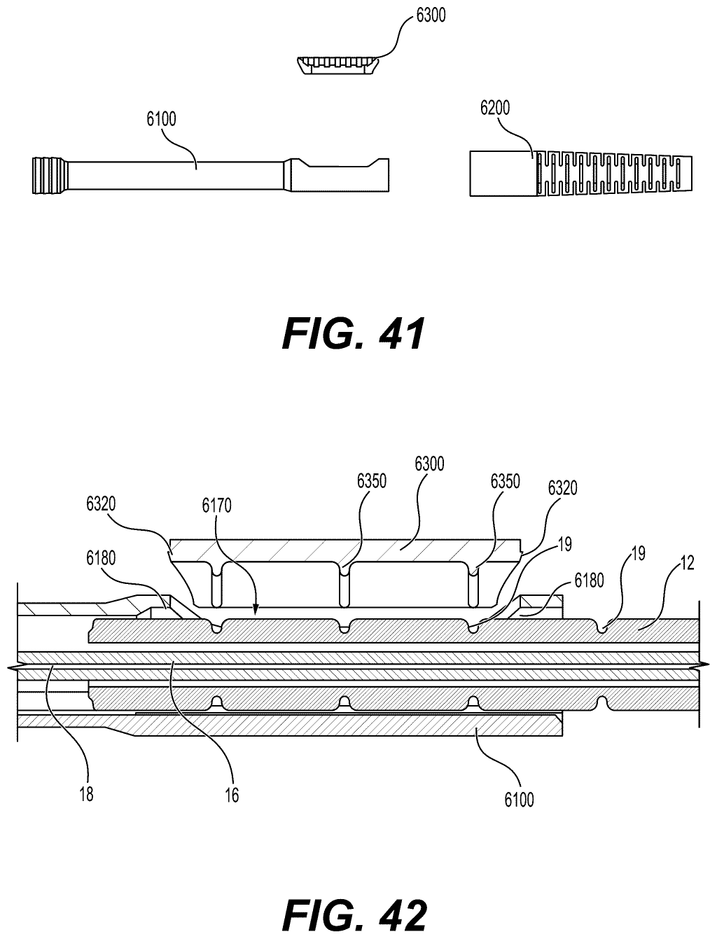

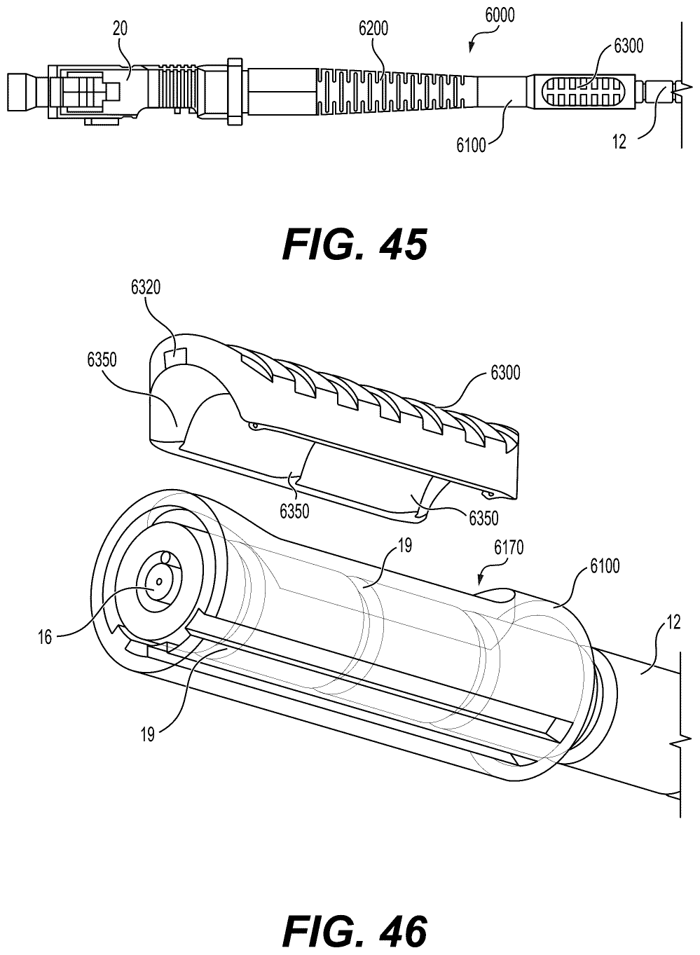

FIGS. 38-46 show an example of a sixth embodiment of a coupler 6000 in accordance with various aspects of the disclosure. In this example, the coupler 6000 has a main body portion such as, for example, a main body 6100, a ferrule 6200, and an insert 6300. The main body portion 6100 has at one end a coupler portion 6154 that, for example, is configured to connect to the optical fiber connector 20. The main body 6100 has an opening 6170 that is configured to receive the insert 6300. The insert 6300 is configured to engage the second portion 12 of the optical fiber cable 10.

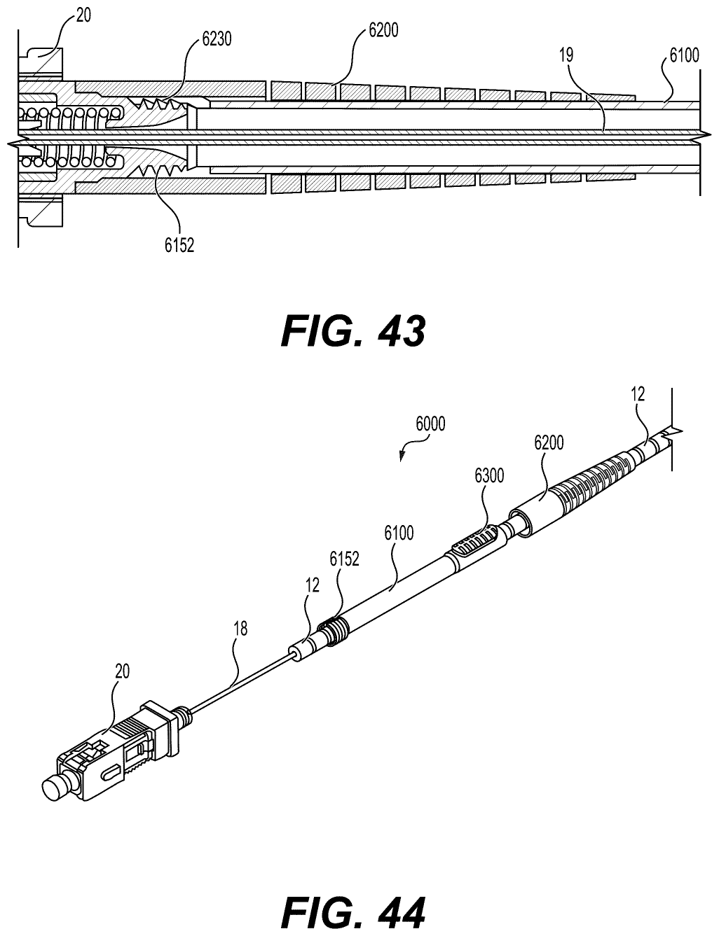

In this example, the main body 6100 provides protection for the exposed portion 18 of the optical fiber 16. The main body 6100 is positioned over the second portion 12 of the optical fiber cable 10 prior to the optical fiber 16, 18 being connected to the optical fiber connector 20. After the optical fiber 16, 18 is connected to the optical fiber connector 20, the main body 6100 is moved toward the optical fiber connector 20 so that the coupler portion 6154 engages, in this example, a threaded portion of the optical fiber connector 20 (see FIG. 43). In this position, the opening 6170 above the second portion 12 of the optical fiber cable 10 (see FIG. 42). The insert 6300 is then inserted in the opening 6170 and, in this example, pressed into a fully engaged position in the opening 6170. In this example, the insert 6300 has a plurality of engagement portions 6350 that engage the grooves 19 in the second portion 12 of the optical fiber cable 10. In this example, the insert 6300 is held in place in the opening 6170 by securing portions 6320 engaging ledges 6180 in the main body 6100 (see FIG. 42). The insert 6300 fixes the main body 6100 relative to the optical fiber cable 10 in the longitudinal direction of the axial fiber cable 10.

After the main body 6100 is in position on the fiber optical connector 20, the ferrule 6200 is moved over the main body 6100 and secured to the optical fiber connector 20. In this example, the ferrule 6200 has a securing portion 6230 that engages a securing portion 6152 on the main body 6100.

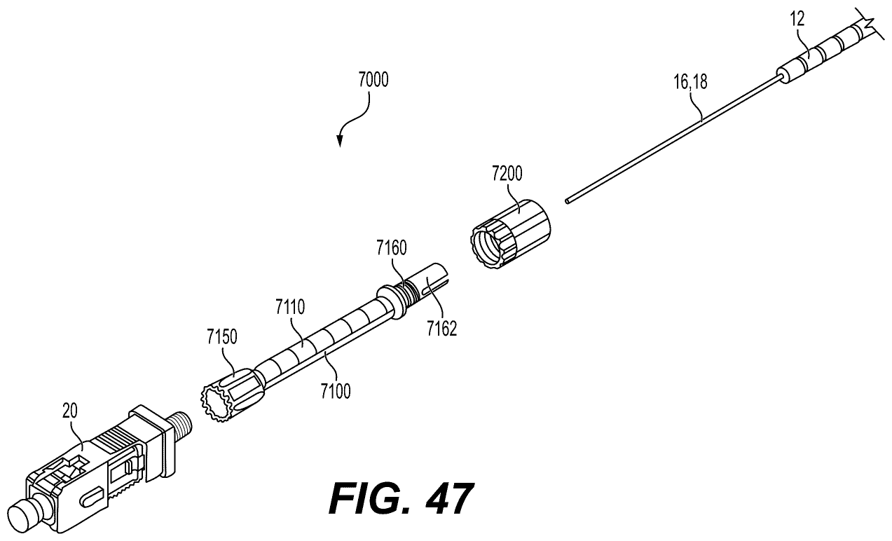

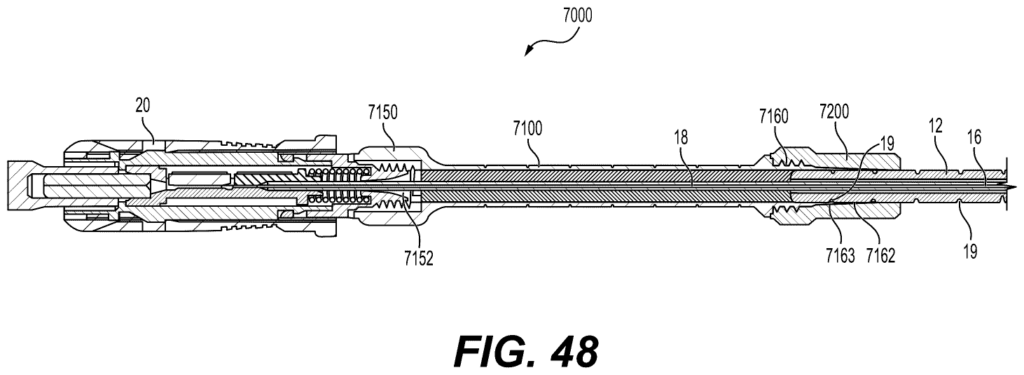

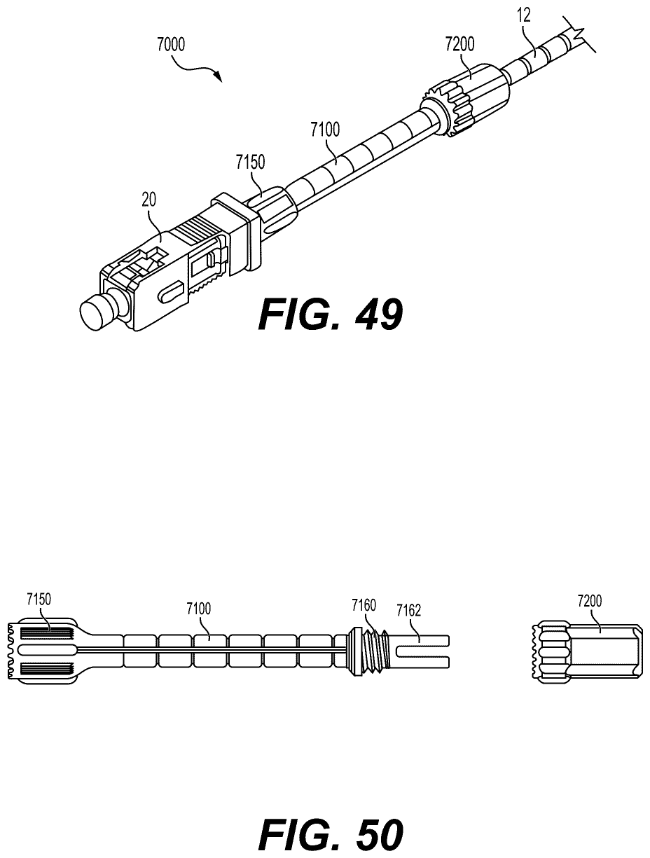

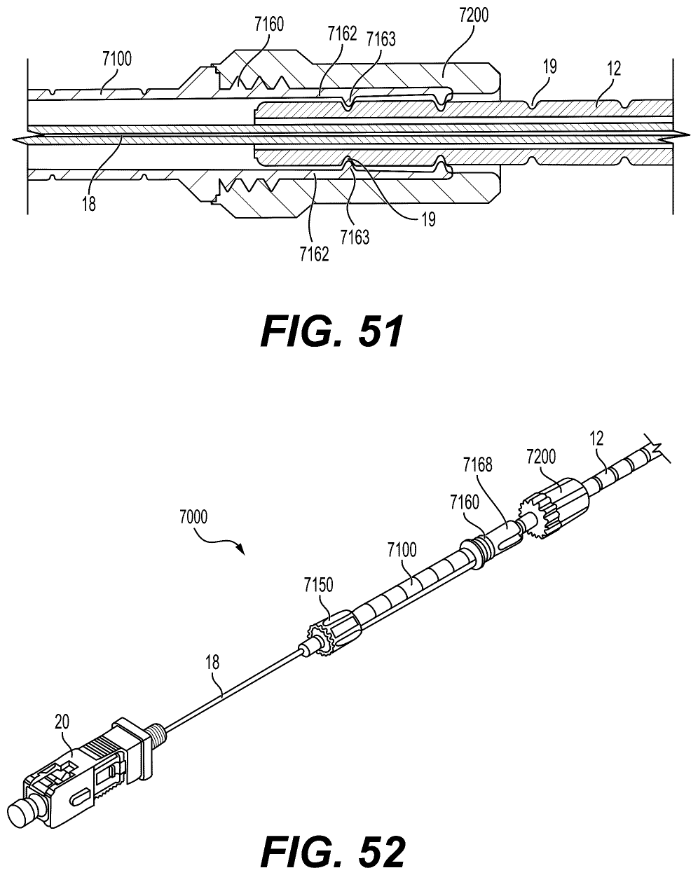

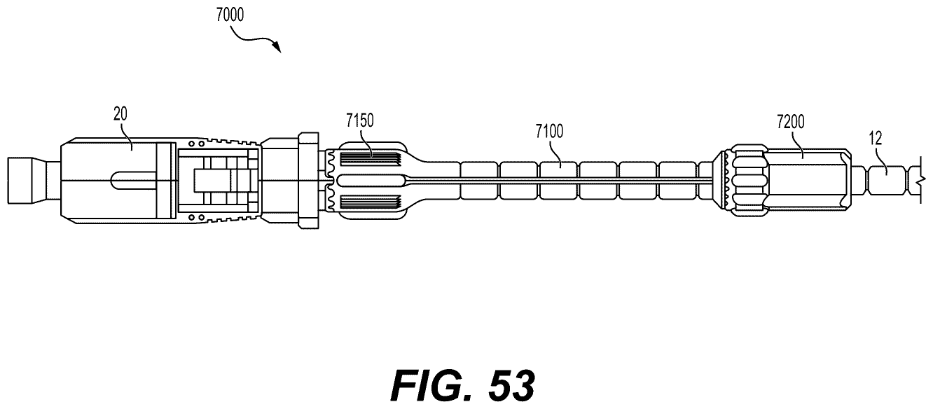

FIGS. 47-53 show an example of a seventh embodiment of a coupler 7000 in accordance with various aspects of the disclosure. In this example, a tubular coupler portion 7100 provides protection for the exposed portion 18 of the optical fiber 16. The tubular coupler portion 7100 and a first coupler portion 7200 are positioned over the second portion 12 of the optical fiber cable 10 prior to the optical fiber 16, 18 being connected to the optical fiber connector 20. After the optical fiber 16, 18 is connected to the optical fiber connector 20, a second coupler portion 7152 of the tubular coupler portion 7100 is moved into contact with, in this example, a threaded portion of the optical fiber connector 20 (see FIG. 48). The first coupler portion 7200 is then moved into contact with, in this example, a clamping portion 7160 of the tubular coupler portion 7100 (see FIG. 47). In this example, the first coupler portion 7200 is threaded onto the clamping portion 7160 and forces one or more clamping extensions 7162 into engagement with the second portion 12 of the optical fiber cable 10. In this example, the clamping extensions 7162 have one or more protrusions 7163 that are configured to engage the grooves 19 of the second portion 12 of the optical fiber cable 10 (see FIG. 51).

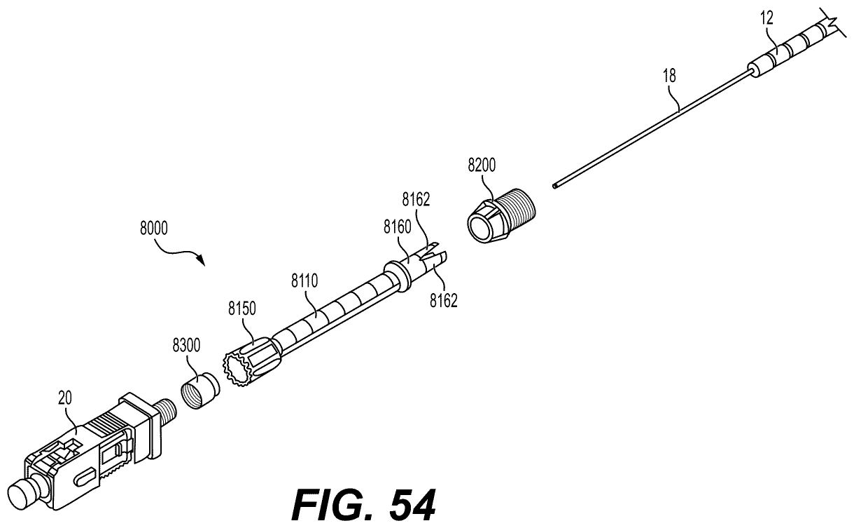

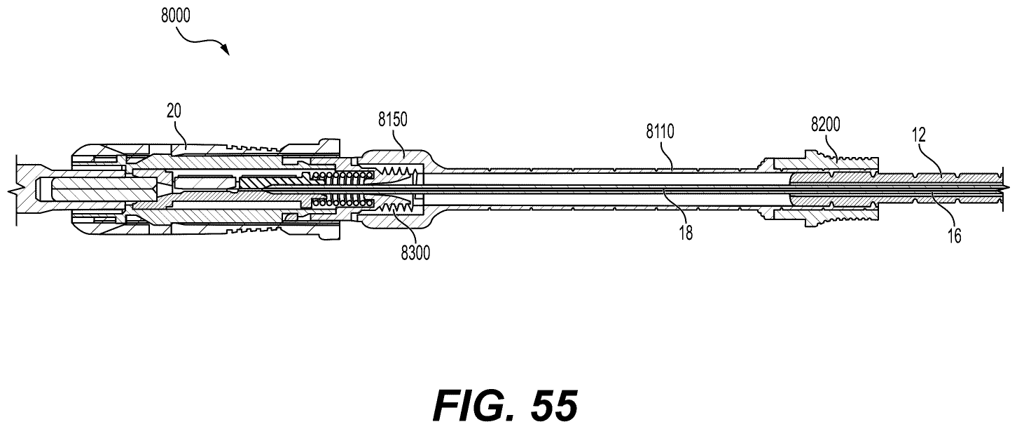

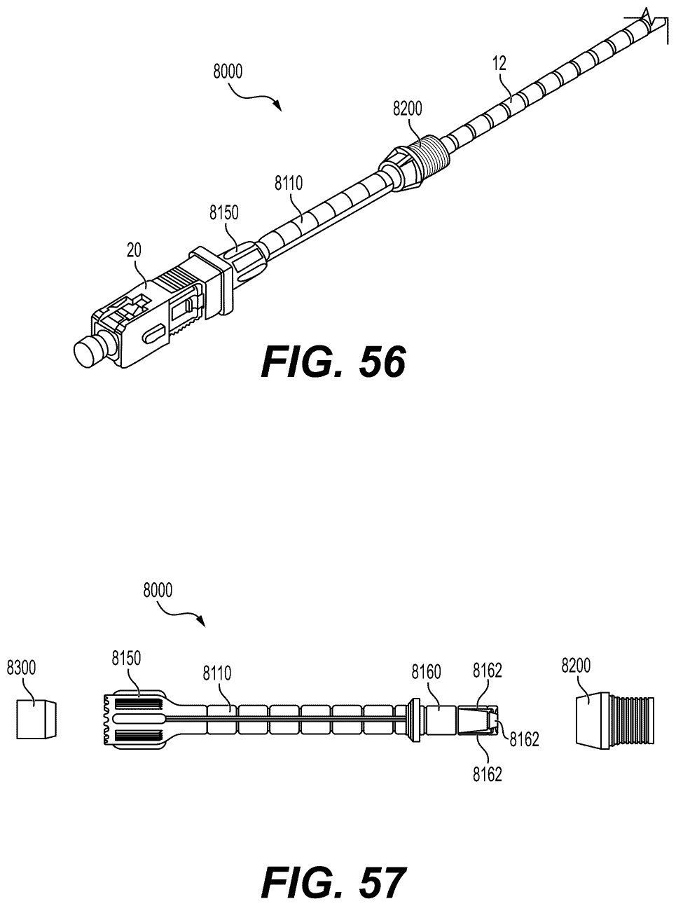

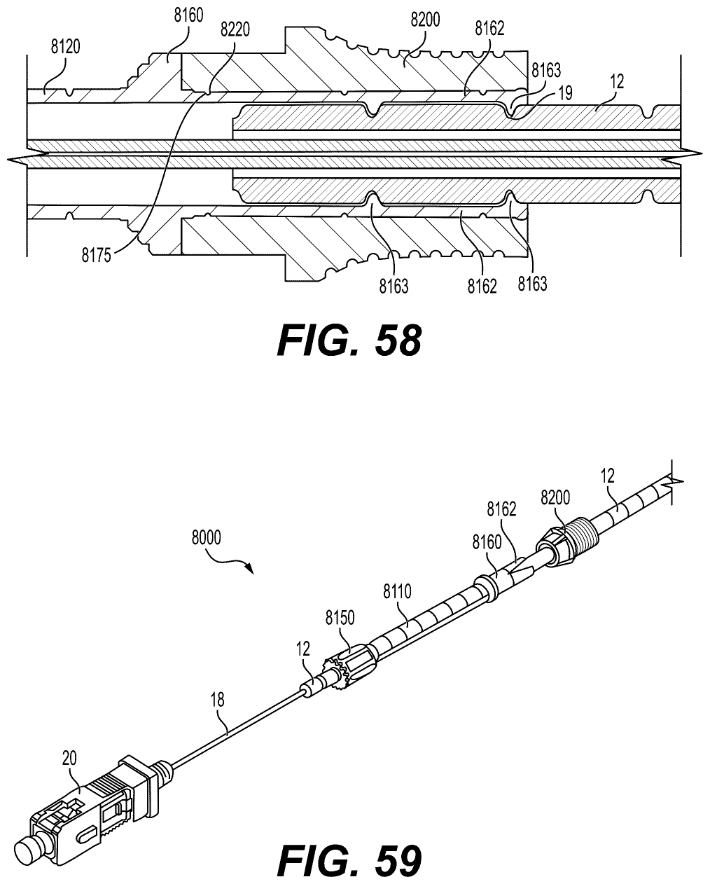

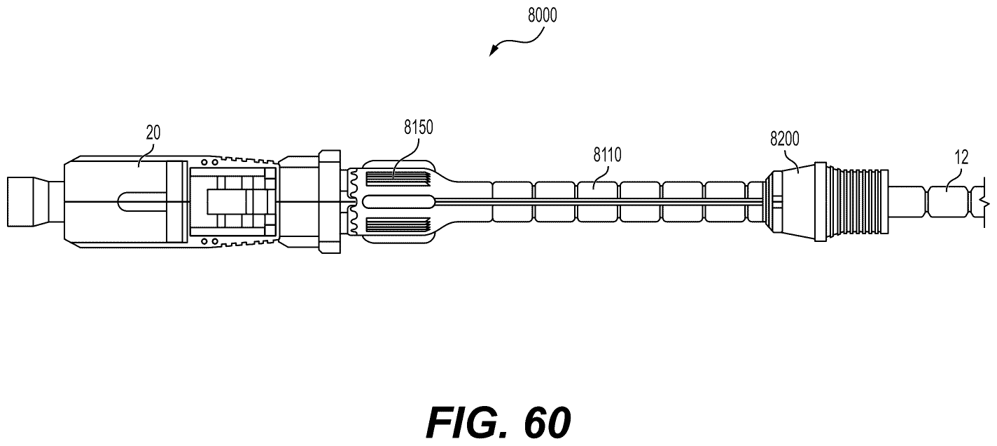

FIGS. 54-60 show an example of an eighth embodiment of a coupler 8000 in accordance with various aspects of the disclosure. In this example, a tubular coupler portion 8100 provides protection for the exposed portion 18 of the optical fiber 16. A first coupler portion 8200, the tubular coupler portion 8100, and a second coupler portion 8300 are positioned over the second portion 12 of the optical fiber cable 10 prior to the optical fiber 16, 18 being connected to the optical fiber connector 20. After the optical fiber 16, 18 is connected to the optical fiber connector 20, the second coupler portion 8300 is moved into contact with, in this example, a threaded portion of the optical fiber connector 20 (see FIG. 54). An end 8150 of the tubular coupler portion 8100 is then moved into position over the second coupler portion 8300. In this example, the end 8150 engages the second coupler portion 8300 with a friction fit. The first coupler portion 8200 is then moved into contact with, in this example, a clamping portion 8160 of the tubular coupler portion 8100 (see FIG. 54). In this example, the first coupler portion 8200 has one or more protrusions 8220 that are configured to engage recesses 8175 on an outer surface of the clamping portion 8160 (see FIG. 58). In this example, the first coupler portion 8200 forces one or more clamping extensions 8162 of the clamping portion 8160 into engagement with the second portion 12 of the optical fiber cable 10. In this example, the clamping extensions 8162 have one or more protrusions 8163 that are configured to engage the grooves 19 of the second portion 12 of the optical fiber cable 10 (see FIG. 58).

Although the exemplary embodiments are described separately herein, it is to be understood that various features and functions of one embodiment can apply to other embodiments.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A coupler configured to cover an exposed portion of an optical fiber in a jacketless portion of a fiber optic cable and mechanically couple the fiber optic cable with a fiber optic connector comprising:
a cover portion structurally configured to be disposed around a fiber optic cable;
a first coupler portion structurally configured to couple the cover portion with the fiber optic cable;
a second coupler portion structurally configured to couple the cover portion with a connector portion;
wherein the connector portion includes a fiber optic connector;
wherein the cover portion is structurally configured to cover a jacketless portion of the fiber optic cable that extends along a length portion of the fiber optic cable between a jacketed portion of the fiber optic cable and the connector portion;
wherein the first coupler portion is configured to overlap a portion of the jacketed portion of the fiber optic cable in a length direction of the fiber optic cable;
wherein the second coupler portion is configured to overlap a portion of the connector portion;
wherein the first coupler portion, the cover portion, and the second coupler portion are structurally configured to provide a mechanical connection between the fiber optic cable and the fiber optic connector so as to enhance a connection of the connector portion to the fiber optic cable; and
wherein the first coupler portion, the cover portion, and the second coupler portion are structurally configured to protect an exposed portion of an optical fiber that extends through the jacketless portion of the fiber optic cable so as to so as to enhance a connection of the fiber optic connector to the fiber optic cable.

2. The coupler of claim 1, wherein the first coupler portion, the cover portion, and the second coupler portion form a clam shell.

3. The coupler of claim 2, wherein the claim shell comprises a first clam shell portion and a second clam shell portion that are connected to each other by a clam shell connector portion.

4. The coupler of claim 1, wherein the second coupler portion comprises a threaded portion that is structurally configured to engage a threaded portion of the fiber optic connector.

5. The coupler of claim 4, wherein the second coupler portion comprises a collet portion that is structurally configured to secure the threaded portion of the second coupler to the threaded portion of the fiber optic connector.

6. The coupler of claim 1, wherein the first coupler portion comprises a collet portion that is structurally configured to secure the first coupler portion to the cable jacket.

7. The coupler of claim 1, wherein the first coupler portion comprises an insert that is separate from the cover portion and is separate from the first coupler portion, and the insert is structurally configured to engage the cable jacket.

8. The coupler of claim 1, wherein the coupler further comprises an outer covering that covers the cover portion, at least a portion of the first coupler portion, and at least a portion of the second coupler portion.

9. The coupler of claim 8, wherein the outer covering comprises a heat shrink tube.

10. A coupler configured to cover an exposed portion of an optical fiber in a jacketless portion of a fiber optic cable and mechanically couple the fiber optic cable with a fiber optic connector comprising:
a cover portion structurally configured to be disposed around a fiber optic cable;
a first coupler portion structurally configured to couple the cover portion with the fiber optic cable;
a second coupler portion structurally configured to couple to the cover portion;
wherein the first coupler portion is configured to overlap a portion of the jacked portion of the fiber optic cable in a length direction of the fiber optic cable;
wherein the first coupler portion, the cover portion, and the second coupler portion are structurally configured to provide a mechanical connection between the fiber optic cable and a fiber optic connector so as to enhance a connection of the fiber optic connector to the fiber optic cable; and
wherein the first coupler portion, the cover portion, and the second coupler portion are structurally configured to protect an exposed portion of an optical fiber that extends through a jacketless portion of the fiber optic cable so as to so as to enhance a connection of the fiber optic connector to the fiber optic cable.

11. The coupler of claim 10, wherein the second coupler portion overlaps a portion of the fiber optic connector.

12. The coupler of claim 10, wherein the jacketless portion exists between the cable jacket and the fiber optic connector.

13. The coupler of claim 10, wherein the first coupler portion, the cover portion, and the second coupler portion form a clam shell.

14. The coupler of claim 13, wherein the claim shell comprises a first clam shell portion and a second clam shell portion that are connected to each other by a clam shell connector portion.

15. The coupler of claim 10, wherein the first coupler portion comprises an insert that is separate from the cover portion and is separate from the first coupler portion, and the insert is structurally configured to engage the cable jacket.

16. The coupler of claim 10, wherein the coupler further comprises an outer covering that covers the cover portion, at least a portion of the first coupler portion, and at least a portion of the second coupler portion.

17. The coupler of claim 16, wherein the outer covering comprises a heat shrink tube.

18. A coupler configured to cover an exposed portion of an optical fiber in a jacketless portion of a fiber optic cable and mechanically couple the fiber optic cable with a fiber optic connector comprising:
a cover portion structurally configured to be disposed around a fiber optic cable;
wherein a jacketless portion of the fiber optic cable extends along a length portion of the fiber optic cable between a jacketed portion of the fiber optic cable and a fiber optic connector;
wherein the cover portion is structurally configured to provide a mechanical connection between the fiber optic cable and the fiber optic connector so as to enhance a connection of the fiber optic connector to the fiber optic cable; and
wherein the cover portion is structurally configured to protect an exposed portion of an optical fiber that extends through the jacketless portion of the fiber optic cable so as to so as to enhance a connection of the fiber optic connector to the fiber optic cable.

19. The coupler of claim 18, wherein the coupler further comprises a first coupler portion structurally configured to couple the cover portion with the fiber optic cable.

20. The coupler of claim 19, wherein the first coupler portion overlaps a portion of a cable jacket of the fiber optic cable.

21. The coupler of claim 19, wherein the coupler further comprises a second coupler portion structurally configured to couple the cover portion with the fiber optic connector.

22. The coupler of claim 21, wherein the second coupler portion overlaps a portion of the fiber optic connector.

23. The coupler of claim 21, wherein the coupler further comprises an outer covering that covers the cover portion, at least a portion of the first coupler portion, and at least a portion of the second coupler portion.
